(19) United States
(12) Patent Application Publication
(10) Pub. No.: US 2007/0106898 A1
(43) Pub. Date: May 10, 2007

(54) Setting information notifying method and appliances applied thereto

(76) Inventors: Mika Mizutani, Tokyo (JP); Yukiko Matsumoto, Yokohama (JP); Takeshi Asahi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/415,281

(22) Filed: May 2, 2006

(30) Foreign Application Priority Data
Nov. 8, 2005 (JP) 2005-323941

(51) Int. Cl. H04L 9/00

(52) U.S. Cl. 713/171; 713/175; 380/278

(57) ABSTRACT

A setting information notifying method that enables safely and easily exchanging appliance setting information between appliances connected to a home network, the said method comprising steps of that: a portable data media is connected to a first appliance which provides a service in a communication network; the first appliance writes on the data media an appliance setting application which is used in notifying the appliance setting information to the other appliance, a host name of the first appliance, and a digital certification with a first cryptographic key; the data media is reconnected to a second appliance which uses the service of the first appliance; and the second appliance identifies a network address of the first appliance based on its host name, and establishes a cryptographic communication using the first cryptographic key over the communication network, and automatically sends the appliance setting information to the first appliance.

### CROSS-REFERENCE TO RELATED APPLICATIONS

The present application claims priority from Japanese Patent Application No. 2005-323941 filed on Nov. 8, 2005, which is herein incorporated by reference.

### BACKGROUND OF THE INVENTION

1. Field of the Invention

The present invention relates to a setting information notifying method with which it becomes possible to safely and easily exchange appliance setting information between appliances constituting a home network, and appliances applied thereto.

2. Description of the Related Art

There is known a so-called home network, where appliances such as a personal computer (hereinafter referred to as PC), a HDD (Hard Drive Disk) recorder, a TV, a printer, and a game machine are communicably connected so as to use their respective services with each other. As a technology to assist in establishing such a home network, for example, there is the UPnP (Universal Plug and Play) protocol to make it possible that, as soon as an appliance is connected to a network (plugged to the cable), information on automatic setting of its address and its device/service characteristics are automatically notified over the communication network. Also, there is a commonly utilized technology, DLNA (Digital Living Network Alliance) which defines the guideline for establishing interoperability throughout a communication network based on UPnP, allowing the appliances to share and view AV (Audio Visual) contents with each other. Due to DLNA, for example, it is made possible to use a PC for viewing contents recorded on a HDD recorder.

Meanwhile, the wireless communication technology (IEEE 802.11b/g/a, etc) is adopted in many home networks for the purpose of simplification of wiring, or for other reasons. In a wireless network, however, it is required to manually set information such as host name, MAC address, and cryptographic key which is to prevent unauthorized accesses such as tapping, to each appliance. Even if using appliances complying with UPnP or DLNA described above, a user has to complete annoyance setting tasks before enjoying the other appliances' resources.

In association with this circumstance, there is raised a need for a system to recognize appliances joining a wireless home network, and safely and easily share appliance setting information including identifier, cryptographic key information, MAC address, and authentication information, among the appliances, in advance of actual communication. Furthermore, for example, a user is out of the house, and views contents recorded on a HDD recorder in the house, or programs recording to the HDD recorder, via the Internet with use of a mobile device such as notebook computer, mobile phone, or in-car terminal. In this case, a mechanism for controlling accesses to the home network appliances should be provided for the purpose of protecting them from possible offences using the Internet. Then, it is urged to realize a mechanism for safely and easily notifying appliance setting information such as authentication information, between the mobile device which is out of the house, and the HDD recorder or another home network appliance which is accessed from the outside.

Conventionally, such notification of appliance setting information is carried out by a user's manually entering this information in each appliance connected in a home network. In order to establish encoded communication between a wireless access point and a PC, a user should first access the wireless access point from the PC through a non-encoded communication, or should connect the PC to the wireless access point with wire. Then the user should set the appliance setting information to the access point. The appliance setting information includes the identifier assigned to the PC, the cryptographic key information such as WEP key, and the MAC address which the user should check up in advance of the setting process. Then again, the user should set to the PC the corresponding identifier and the key information in the same manner. During this setting process, the user has to correctly memorize the appliance setting information and carefully enter those data in the respective components. If there are a number of appliances to be connected to the wireless access point, this task turns out a rather heavy load for the user. In addition, in the case of using a wireless communication as the setting mean, the first contact to a wireless access point to enter the required information is mostly made through a non-encoded communication; thus, a possibility to be tapped arises.

As one of attempts at improving this process, Japanese. Patent Application Laid-open Publication No. 2004-328093 (the corresponding U.S. Patent Published Application: US 20040215815A1) has disclosed a method in which recognition between two appliances and connection thereafter are established by just pushing their corresponding user interfaces simultaneously and adjusting the timing of releasing these push operations. However, such operations should be appended with difficulty in some cases. For example, as is often with the case with home networks, an appliance to be set is a TV placed away from the other one.

Japanese Patent Application Laid-open Publication No. 2004-215232 is taken as another related art. This publication has disclosed a technology in which an access point narrows its coverage of wireless communication in response to manipulation of a registration button, so that a secured communication area is defined, then registering MAC address and key information to add a new terminal to the network can be processed within the secured wireless network. In this technology, however, there is a possibility that an unauthorized terminal could exist in even the above-mentioned secured communication area so that tapping could be committed. On top of that, both of the two publications just refer to the case that only a single service is performed (a wireless communication service, etc.). Therefore, in the case of including a plurality of appliances or services, these technologies do not become a real solution, and there is still a security problem left to be taken care of more thoroughly.

The present invention has been contrived in consideration of the above-mentioned circumstance. It is an object of the present invention to provide a setting information notifying method with which it becomes possible to safely and easily exchange appliance setting information between appliances constituting a home network, and appliances applied thereto.

### SUMMARY OF THE INVENTION

The main part of the present invention to accomplish the above-mentioned object is a setting information notifying method which is used to notify appliance setting information, the information required for use of a service between a first appliance and a second appliance, in an appliance communication system including the first appliance which is used with being connected to a communication network and the second appliance which is used with being connected to the communication network, the setting information notifying method, comprising steps of the first appliance storing a program which is used in notifying the application setting information to the other appliance, a first identifier assigned to the first appliance, and a first cryptographic key of the first appliance, on a portable data media, the second appliance starting the program stored on the data media, to obtain a first network address assigned to the first appliance based on the first identifier, and to establish a cryptographic communication path with the first appliance with use of the first cryptographic key stored on the data media; the first appliance sending the appliance setting information to the second appliance through the cryptographic communication path; and the second appliance sending a second identifier assigned to the second appliance to the first appliance through the cryptographic communication path.

According to the present invention, it is realized to safely and easily exchange appliance setting information in an appliance communication system including a first appliance which is used with being connected to a communication network such as a home network or the Internet, and a second appliance which is used with being connected to the communication network. In the present invention, for example, a program which is used in informing the other appliance of the appliance setting information such as a WEP key on a wireless LAN, an identifier of the first appliance, and a cryptographic key (digital certification) of the first appliance can be transferred, from the first appliance which provides a service to the second appliance which uses the service, with use of a data media such as an USB memory as a carrier. Then, the second appliance can automatically connect to the first appliance, and safely and easily notify the appliance setting information required for the first appliance to offer the service, through a cryptographic communication.

In addition, the other main part of the present invention is the setting information notifying method further comprising steps of the first appliance determining whether or not it stores a third cryptographic key, with regard to a third appliance which is used with being connected to the communication network; and if the first appliance stores the third cryptographic key, then the first appliance sending to the second appliance the third cryptographic key and a third identifier assigned to the third appliance.

In this way, if the first appliance, which has already been notified the appliance setting information, contains the third cryptographic key regarding to the third appliance, the first appliance notify to the second appliance the third cryptographic key and the third identifier. Thus, a user of the second appliance can safely and easily use a service of the third appliance, without the need for him/herself to manually configure the appliance setting information in each of the second and the third appliances.

In sum, the present invention enables easy and safe configuration of appliance setting information.

### BRIEF DESCRIPTION OF THE DRAWINGS

FIG. 1 is a schematic diagram showing a configuration of an appliance communication system 1, which is one embodiment of the present invention;

FIG. 1A shows a hardware configuration of appliances 100 which is used with being connected to a home network 50, while the home network 50 is a part of the embodiment of the present invention;

FIG. 1B shows programs and data stored on a memory 113 or an external storage unit 105 of each of the said appliances 100;

FIG. 1C shows an example of a service-to-use table 121 and a client-to-serve table 122, which are parts of the embodiment of the present invention;

FIG. 1D shows an example of a temporary digital certification 125 and a digital certification 127, which are parts of the embodiment of the present invention;

FIG. 2A shows a hardware configuration of a data media 103, which is a part of the embodiment of the present invention; FIG. 2B shows a program and data stored on a nonvolatile memory 112 of the said data media 103;

FIG. 3 is a flow chart showing a process of notifying appliance setting information, the process is executed automatically between an appliance 100A which provides a service, and an appliance 100B which receives the service, while the appliances 100A and 100B are parts of the embodiment of the present invention;

FIG. 4 is a flow chart showing a process executed between the appliance 100A and the appliance 100B in order for the appliance 100A to receive a service from the appliance 100B, in the case that the appliance 100B also provides the service;

FIG. 5 is a flow chart showing processes of registering data on the service-to-use table 121, and registering data on the client-to-serve table 122 by the appliance 100A or 100B;

FIG. 6 is a flow chart showing a process executed as a preparation for the appliance 100B to receive a service from an appliance 100C which is a part of the embodiment of the present invention;

FIG. 7 is a flow chart showing a process executed after the appliance 100B detects the service of the appliance 100C; FIG. 8 is a flow chart showing a process executed by an appliance setting information delete program 700, which is a part of the embodiment of the present invention.

### DETAILED DESCRIPTION OF THE INVENTION

In the following, one embodiment of the present invention is described in detail with reference to the accompanying drawings.

== System Configuration ==

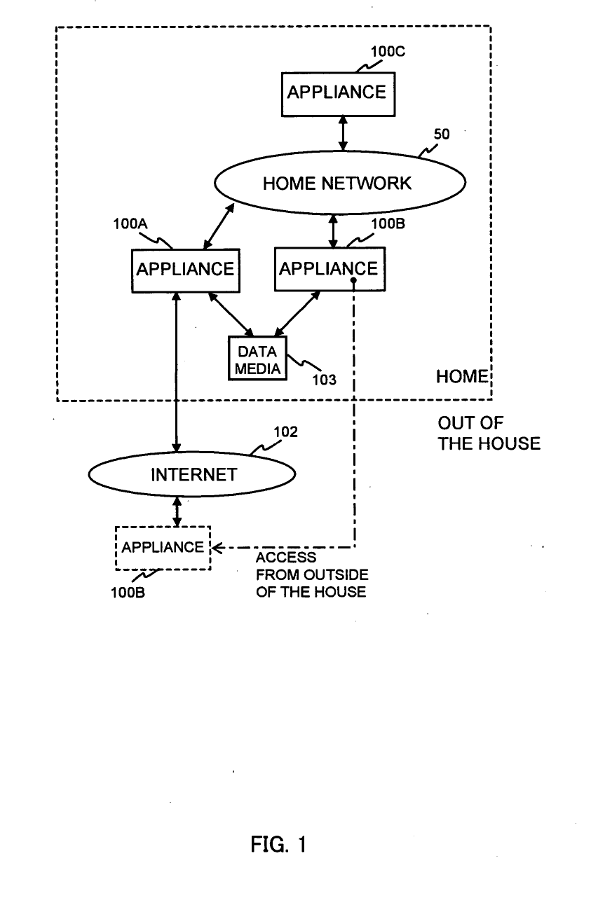

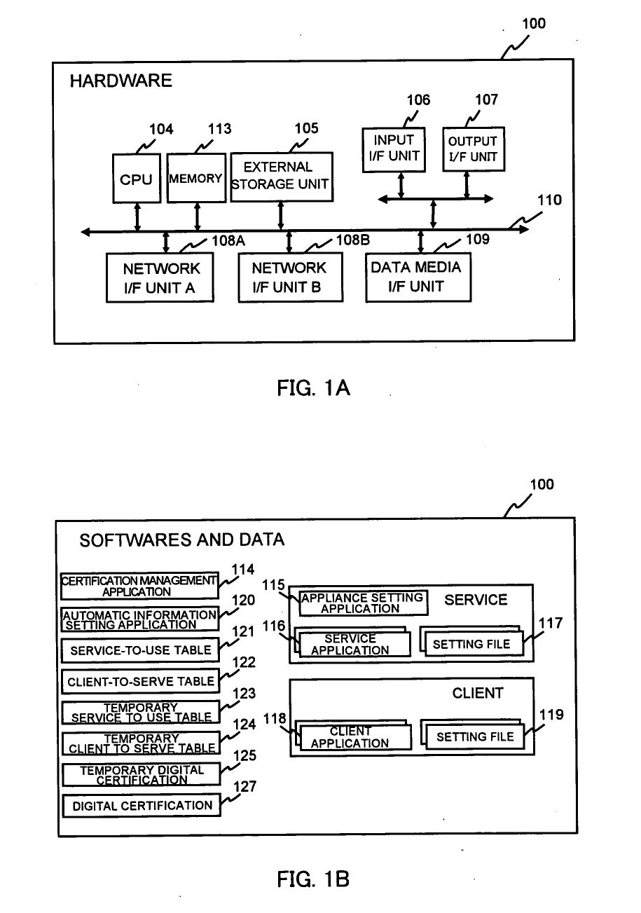

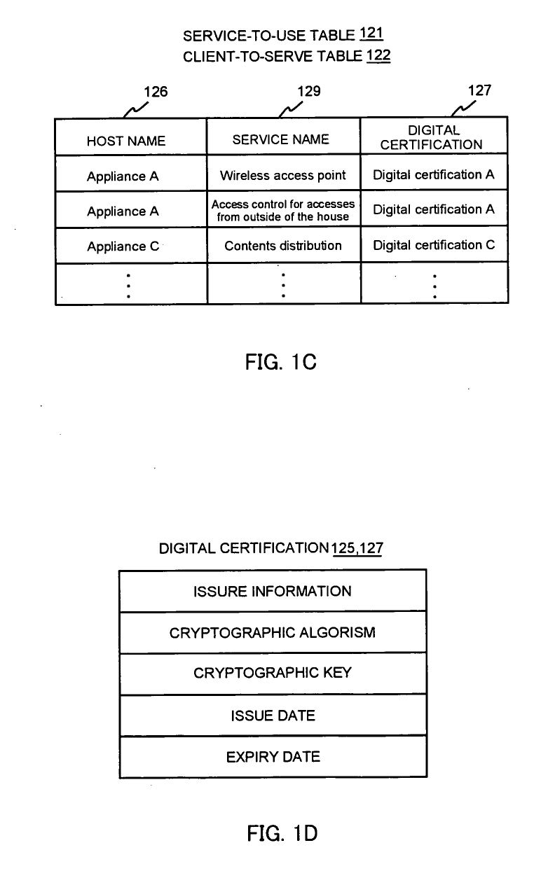

FIG. 1 is a schematic diagram showing a configuration of an appliance communication system 1 which is the embodiment of the present invention. The appliance communication system 1 includes a home network 50 laid in an appropriate area in a home environment, appliances 100 (100A, 100B, and 100C) such as PCs and consumer electronics which are used with being connected to the home network 50. A data media 103 shown in FIG. 1 is utilized as a tool for conveying appliance setting information between the appliances. That is, when an appliance 100 connected to the home network 50 is going to use a service provided by the other appliance 100, the data media 103 carries authentication information which is used in authentication process prior to service providing, and appliance setting information which is used in cryptographic communication between the appliances 100, conveying those data from the server appliance 100 to the client appliance 100.

FIG. 1A shows an example of a hardware configuration of the appliance 100 which is used with being connected to the home network 50. The appliance 100 includes a CPU 104, a memory 113, an external storage unit 105 which is a readable/writable nonvolatile memory such as a hard disk drive, a CD/DVD drive, or a flash memory, an output interface unit 107 which is connected to an output device such as a CRT or a LC display, an input interface unit 106 which is connected to an input device such as a keyboard, a mouse, or a remote control, a network interface unit 108A which is an interface to ADSL (Asymmetric Digital Subscriber Line) or the optical communication line (Fiber to the Home) to connect to the Internet, a network interface unit 108B which is an interface to the home network 50, a data media interface unit 109 which is an interface to the data media 103, and a bus 110 which connects the above-mentioned components with each other.

With regard to the external storage unit 105, the input interface unit 106, the output interface unit 107, and the network interface unit 108A, the appliances 100 are not necessary equipped with all of them. For example, in the case that an appliance 100 is a home router, a file server, or a media server, the appliance might not include the external storage unit 105, the input interface unit 106, and the output interface unit 107. In addition, in the case that an appliance 100 is a hard disk recorder (HDD recorder), the appliance might not include the network interface unit 108A. In the following description, the appliance 100A shown in FIG. 1 is assumed to be a home router for use in connecting the home network 50 to the Internet 102, while the appliance 100B is assumed to be a portable computer such as a notebook computer, and the appliance 100C is assumed to be a hard disk recorder.

FIG. 1B shows programs and data stored on the memory 113 or the external storage unit 105 of each appliance 100 connected to the home network 50. As shown in FIG. 1B, the appliance 100 stores various application programs including a certification management application 114, an appliance setting application 115, a function as a wireless LAN access point, a mechanism for controlling accesses from outside of the house, a service application 116 to provide a service such as contents distribution, a client application 118, and automatic information setting application 120. The certification management application 114 is responsible for managing digital certifications which are used in providing or using a service between the appliances 100. The appliance setting application 115 functions to assist in automatically notifying appliance setting information by the appliance 100. The appliance setting information is information required in using a service between the appliances 100 joining the home network 50; for example, WEP key (Wired Equivalent Privacy Key), which is used in communication on a wireless LAN, is included in this information.

The service application 116 contains programs and data necessary to provide a service. In the following description, it is assumed that the appliance 100A has the service application 116 which provides a function as a wireless access point and a mechanism for controlling accesses from outside of the house, while the appliance 100C has the service application 116 which provides a service of contents distribution. The setting file 117 contains information regarding to clients which the appliance 100 serves. The client application 118 contains programs and data necessary to use a service. The setting file 119 contains information regarding to services which the appliance 100 can use.

The automatic information setting application 120 comprises a program to provide a function regarding to setting various information, a program to provide a function regarding to accepting service-use requests, a service-use request send program 600 to provide a function regarding to sending service-use requests, and an appliance information delete program 700 to make an appliance 100 unusable in the home network 50.

In addition to the programs and data described above, the memory 113 or the external storage unit 105 of the appliance 100 stores a temporary digital certification 125, a digital certification 127, a service-to-use table 121, a client-to-serve table 122, a temporary service-to-use table 123, and temporary client-to-serve table 124.

FIG. 1C shows an example of the service-to-use table 121 and the client-to-serve table 122. The tables 121 and 122 respectively comprise items of a host name 126 which contains the name of an appliance 100, a service name 129, and a digital certification 127. The digital certification 127 is used in automatically notifying the appliance setting information between the appliances 100, and is issued for each server/client. The temporary service-to-use table 123 and the temporary client-to-serve table 124 respectively comprise items of the host name 126 and the digital certification 127 in the same manner.

FIG. 1D shows an example of the temporary digital certification 125 and the digital certification 127. The temporary digital certification 125 and the digital certification 127 contain issuer information for identifying the issuing appliance such as a product number, a cryptographic algorism, a cryptographic key, an issue date, and an expiry date. As the cryptographic key, either a public key or a pre-shared key can be used. If a public key is used as the cryptographic key, the certification management application 114 manages the digital certifications along with the corresponding private key. If a pre-shared key is used as the cryptographic key, the certification management application 114 manages only the digital certifications. The data media 103 is a portable storage media. Specifically, an USB memory (Universal Serial Bus Memory), or a mobile communication device equipped with memory and short-distance wireless communication function, such as a mobile phone or a PDA, can be used as the data media 103. In the following description, the data media 103 is assumed to be an USB memory.

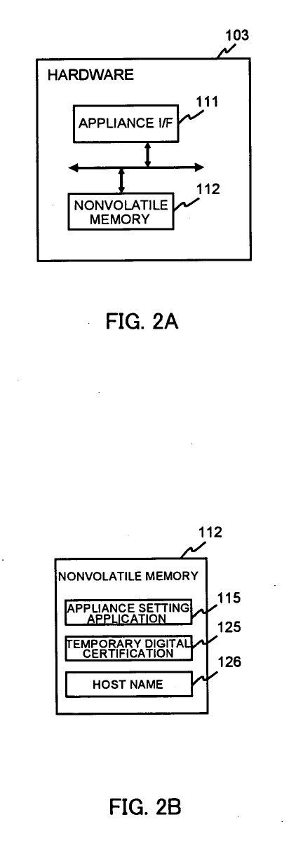

FIG. 2A shows an example of a hardware configuration of the data media 103. The data media 103 comprises a nonvolatile memory 112 such as a flash memory, and an appliance interface 111 which can be connected to the data media interface 109 of the appliance 100.

FIG. 2B shows a program and data stored on the nonvolatile memory 112 of the data media 103. In the data media 103, the appliance setting application 115, the temporary digital certification 125 (a first cryptographic key), the host name 126 and other data are written by the appliance 100. More details of contents and usage of these data are described later on.

== Functions ==

Next, a detailed description is provided regarding to a process of notifying the appliance setting information, which is executed as a preparation for an appliance 100 to use a service of the other appliance 100.

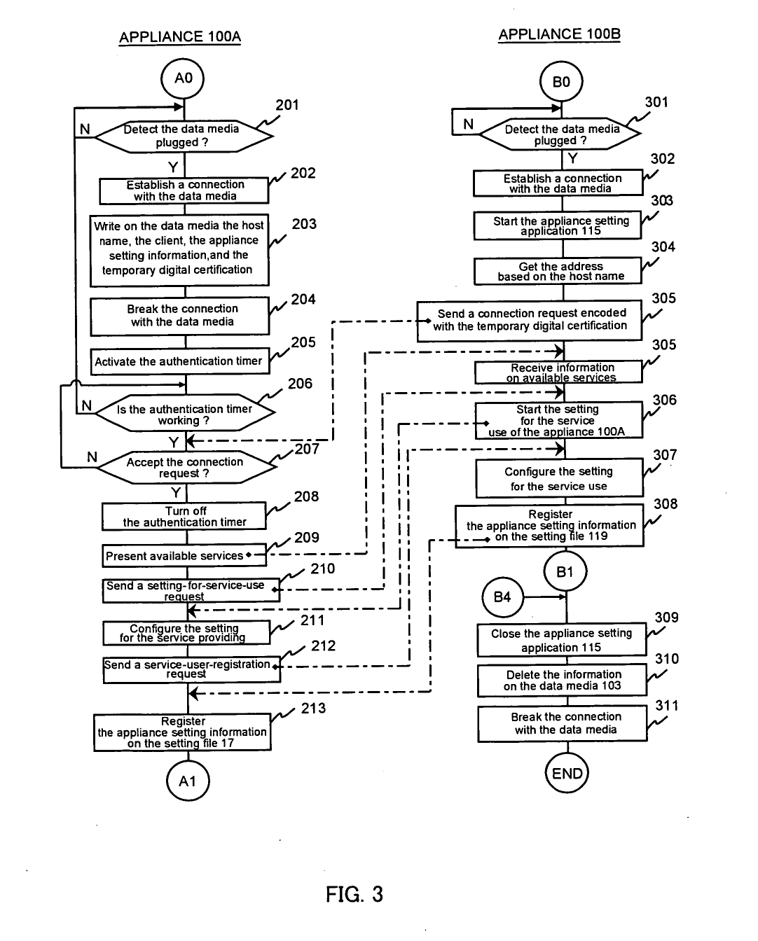

FIG. 3 is a flow chart showing a process of notifying the appliance setting information, which is executed automatically between the appliance 100A which provides a service, and the appliance 100B which uses the service. This process is described with reference to the flow chart of FIG. 3.

As shown in FIG. 3, first, a user plugs the data media 103 into the appliance 100A. On detecting that the data media 103 is plugged (201: Y), the appliance 100A establishes a connection with the data media 103 (202), and writes on the data media 103 the appliance setting application 115 that assists in notifying the appliance setting information, the host name assigned to the appliance 100A (a first identifier), and the temporary digital certification 125 (a first cryptographic key) (203). At this moment, it does not matter whether the data media 103 is just formatted and empty, or holds any data written already. In the case of the latter, for example, the appliance setting information and the other information may be saved in a specific folder.

After completing writing the above-mentioned information on the data media 103, the appliance 100A breaks the connection established with the data media 103 (204), so that the data media 103 can be removed from the appliance 100A. Then, the appliance 100A activates a timer which is used in managing the expiry date of the digital certification (hereinafter referred to as authentication timer) (205). When the authentication timer reaches a time-out, the appliance 100A voids the digital certification stored on the data media 103.

In the next step, after confirming that the data media 103 can now be removed, the user unplugs the data media 103 from the appliance 100A, and again plugs it into the appliance 100B before the timeout comes. It is beneficial, as far as security concerned, to impose the expiry date on the digital certification in this way. For example, with the expiry date imposed, it can be prevented that appliance setting procedure automatically starts off without a user's intention, that otherwise might be caused with a data media 103 left untouched. The authentication timer, for example, can be set to take a timeout per tens of minutes. On detecting that the data media 103 is plugged (301: Y), the appliance 100B establishes a connection with the data media 103 (302).

Once establishing this connection, the appliance 100B launches the appliance setting application 115 stored on the data media 103 (303). This enables a process that the appliance setting information is automatically exchanged between the appliance 100A and the appliance 100B (hereinafter referred to as setting information automatic notifying process) to start. At this point, the appliance setting application 115 can be loaded into the memory 113 of the appliance 100B to be launched, or stay in the nonvolatile memory 112 of the data media 103 to be launched from there.

The setting information automatic notifying process is executed as follows. In the first step, the appliance 100B sends the “ping” command onto the home network 50, and obtains the IP address corresponding to the host name 126 stored in the data media 103, that is, the IP address of the appliance 100A (304). Then, the appliance B starts a cryptographic communication with the appliance 100A, which is encoded with the cryptographic key stored in the temporary digital certification on the data media 103.

In the second step, the appliance 100B sends a connection request to the appliance 100A (305). On receiving this request, the appliance 100A first determines whether or not the authentication timer has passed the time-out (206). If not (206: Y), the appliance 100A decodes packets sent from the appliance 100B (hereinafter referred to as received packet) with use of the cryptographic key in the temporary digital certification 125, to confirm that the connection request is actually sent from the appliance 100B (207). Then, the appliance 100A turns off the authentication timer (208). After that, the appliance 100B continues the communication encoded with the cryptographic key in the temporary digital certification 125 (hereinafter referred to as temporary cryptographic communication), with the appliance 100A.

If the time-out has expired (206: N), the appliance 100A cannot decode the received packets because the temporary digital certification corresponding to that stored on the data media 103 is already deleted. Therefore, the appliance 100A cannot verify the received connection request (207: N), then goes back to the step 206.

In the third step, the appliance 100A informs the appliance 100B of services available to the appliance 100B, through a temporary cryptographic communication (209), and the appliance 100B receives that information from the appliance 100A (305). Here, it is assumed that the services which appliance 100A presents to the appliance 100B are a service as a wireless access point, and a service for accesses from outside of the house (209).

In the fourth step, the appliance 100A sends to the appliance 100B a setting-for-service-use request which is to request to configure the setting required to start the service use (210). Here, it is assumed that the appliance 100A's request toward the appliance 100B is regarding to the service as a wireless access point. On receiving this request, the appliance 100B creates the application setting information required to use the wireless access point service, with regard to the appliance 100A (here this information is assumed to be a WEP key) (306).

In the fifth step, the appliance 100A sends to the appliance 100B a service-user-registration request which is request to make service user registration (212). On receiving this request, the appliance 100B registers the created appliance setting information with regard to the appliance 100A, as the confirmed appliance setting information (307).

In the sixth step, the appliance 100B sends its own MAC address to the appliance 100A. The appliance 100A stores the identifier of the appliance 100B (a second identifier), the WEP key, and the received MAC address, on the setting file 117 of the service application 116 (213). Meanwhile, the appliance 100B stores the appliance setting information on the setting file 119 of the client application 118 (308). In the case that the appliance 100A provides a plurality of services in the home network 50, the above-mentioned fifth to sixth steps are repeated for each service. For the service that the appliance 100B is already using, the setting procedure to use this service may be omitted.

In the step 210, if the appliance 100B which is out of the house, and a setting-for-service-use request which the appliance 100A sends is regarding to the service for accesses from outside of the house, the appliance 100A, for example, stores the MAC address of the appliance 100B, the digital certification which is used in the service providing, and the cryptographic key corresponding to this digital certification, as the appliance setting information on the setting file 117 of the service application 116. Meanwhile, the appliance 100B stores the digital certification as the appliance setting information on the setting file 119 of the client application 118.

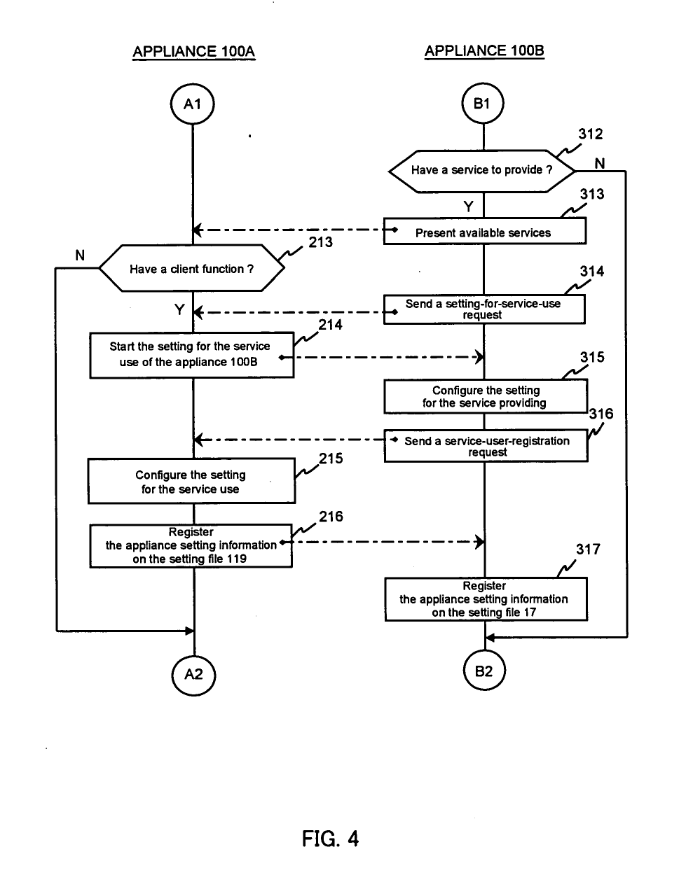

FIG. 4 is a flow chart showing a process executed between the appliance 100A and the appliance 100B in order for the appliance 100A to receive a service from the appliance 100B, in the case that the appliance 100B provides the service, too. The process shown in FIG. 4, for example, starts at the point of the terminal markings A1 and B1 in FIG. 3.

In the first step, the appliance 100B determines whether or not the appliance 100B has the service application 116 (312), as well as the appliance 100A determines whether or not the appliance 100A has the client function (213). If the appliance 100B has the service application 116 (312: Y, 313), and the appliance 100A has the client function (213: Y), then the appliance 100A receives a setting-for-service-use request sent from the appliance 100B (314), then the setting required for the service use is started (214 and 315).

In the second step, the appliance 100B sends a service-user-registration request to the appliance 100A to make service user registration (316). In response to this request, the appliance 100A registers the appliance setting information received from the appliance 100B, such as the host name of the appliance 100B (the second identifier) and the cryptographic key information such as the WEP key, on the setting file 119 of the client application 118 (215). Then, the appliance 100A sends its own MAC address to the appliance 100B, and registers the appliance setting information, that is, the host name of the appliance 100B (the second identifier) and the cryptographic key information, as the confirmed information on the setting file 119 of the client application 118 (216). Meanwhile, the appliance 100B stores the appliance setting information regarding to the appliance 100A such as the identifier of the appliance 100A (the first identifier), the WEP key, and the MAC address, on the setting file 117 of the service application 116 (317). In the case that the appliance 100B provides a plurality of services, the above-mentioned second step is repeated for each service. For the service that the appliance 100A is already using, the setting procedure to use this service may be omitted.

In this embodiment described up until now, the appliance 100A or 100B automatically configures the setting for the service being provided by the appliance 100B or 100A. However, with using an appliance 100A or 100B equipped with an output unit such as a display as a user interface, and an input unit such as a keyboard or a remote control, it is possible to show available services of the other appliance 100 on the display so that a user can select whatever service he/she wants to use.

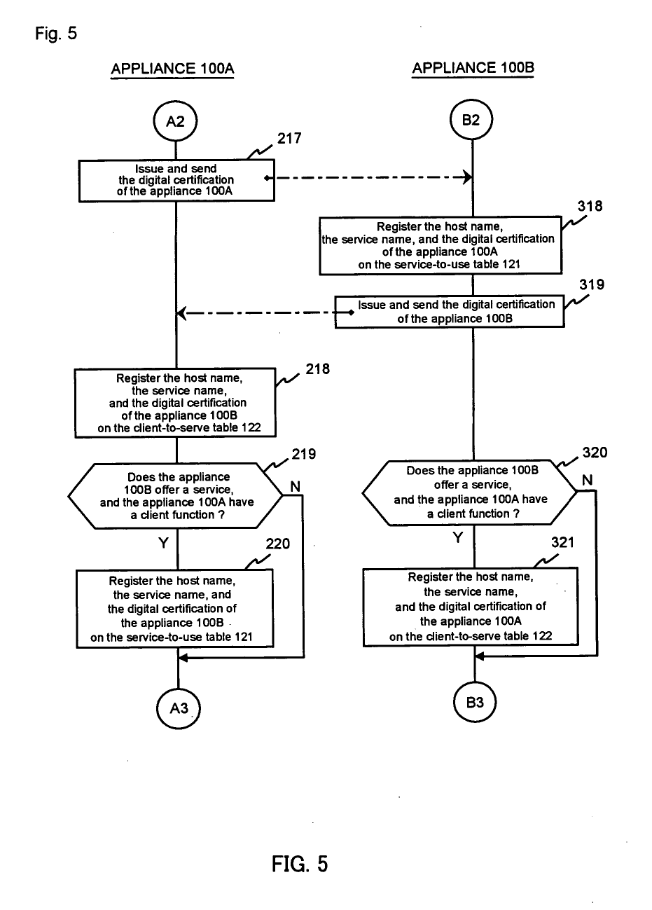

FIG. 5 is a flow chart showing processes of registering data on the service-to-use table 121, and registering data on the client-to-serve table 122 by the appliance 100A or 100B. The process shown in FIG. 5, for example, starts at the point of the terminal markings A2 and B2 in FIG. 4.

In the first step, the appliance 100A issues for the appliance 100B a digital certification 127 for use in the setting information automatic notifying process. Then, the appliance 100A sends it to the appliance 100B (217).

In the second step, the appliance 100B registers the host name 126 of the appliance 100A, the service name 129, and the digital certification 127 sent from the appliance 100A, on the service-to-use table 121 (318).

In the third step, the appliance 100B issues a digital certification 127 for the appliance 100A, and sends it to the appliance 100A (319).

In the fourth step, the appliance 100A registers the host name 126 of the appliance 100B, the service name 129, and the digital certification 127 sent from the appliance 100B, on the client-to-serve table 122 (218).

In the fifth step, the appliance 100A determines if the appliance 100B provides any service as well as the appliance 100A has a function as a client (219). If both conditions are met (219: Y), the appliance 100A stores the host name 126 of the appliance 100B, the service name 129 to be provided, and the digital certification 127 of the appliance 100B, on the service-to-use table 121 (220). Furthermore, the appliance 100B also determines if the appliance 100B provides any service as well as the appliance 100A has a function as a client (320). If both conditions are met (320: Y), the appliance 100B stores the host name 126 of the appliance 100A, the service name 129 to provide, and the digital certification 127 of the appliance 100A, on the client-to-serve table 122 (321).

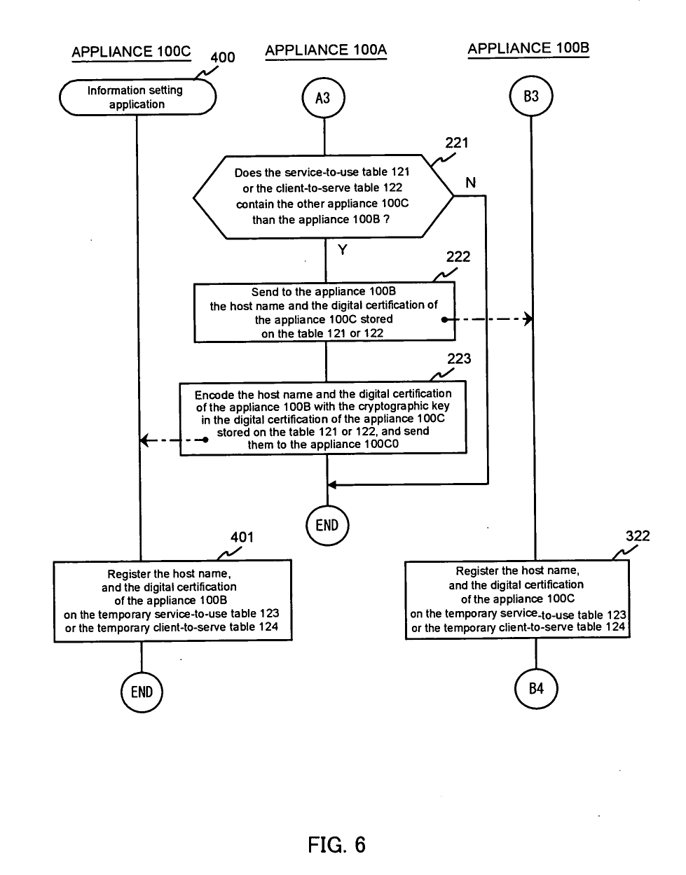

FIG. 6 is a flow chart showing a process executed as a preparation for the appliance 100B to use a service being provided by the other appliance 100C than the appliance 100A (this process is hereinafter referred to as preparation process). This preparation process, for example, may be executed after the setting information automatic notifying process is carried out between the appliances 100A and 100C.

In the first step, the appliance 100A determines whether or not its own service-to-use table 121 or client-to-serve table 122 contains information regarding a service of the other appliance 100 than the appliance 100B (221). Here, it is assumed that the appliance 100A's service-to-use table 121 or client-to-serve table 122 contains the information regarding the appliance 100C (221: Y).

In the second step, the appliance 100A sends to the appliance 100B the host name 126 of the appliance 100C and the digital certification 127 (a third cryptographic key) stored on the service-to-use table 121 or the client-to-serve table 122 (222).

On receiving this information from the appliance 100A, the appliance 100B registers it on its own temporary service-to-use table 123 or the temporary client-to-serve table 124 (322).

In the third step, the appliance 100A encodes the host name 126 of the appliance 100B and the digital certification 127 (the second cryptographic key) of the appliance 100B with use of the cryptographic key in the digital certification 127 of the appliance 100C, and send those data to the appliance 100C (223). After the appliance 100C receives this information from the appliance 100A, an information setting application 400 running on the appliance 100C decodes the host name 126 and the digital certification 127 sent from the appliance 100A, with use of the cryptographic key in the digital certification managed by the certification management application 114. Then, the appliance 100C registers the decoded information about the appliance 100B (the host name 126 and the digital certification 127), on its own temporary service-to-use table 123 or the temporary client-to-serve table 124 (401).

The terminal marking B4 shown in FIG. 6 corresponds to the terminal marking B4 shown in FIG. 3. In the fourth step, the appliance 100B closes the appliance setting application 115, as shown in FIG. 3 (309). Then, the appliance 100B deletes the information stored on the data media 103 (310), and breaks the connection established with the data media 103 (311).

As for the setting information automatic notifying process between the appliances 100A and 100B shown in FIG. 3, this process is completed by taking the steps 309 to 311, and from that time on, it becomes possible to exchange services between the appliances 100A and 100B. The communication in this process is the cryptographic communication with use of the cryptographic key in the temporary digital certification 125 and the cryptographic key in the corresponding temporary digital certification 125.

Back to the case that the appliance 100B uses the service of the appliance 100C, now a description is provided regarding to a process executed after the above-mentioned preparation process. This process enables the appliance 100B to actually receive the service offered by the appliance 100C. In this process, first, the appliance 100B detects a service which the appliance 100C offers in the home network 50. Such detection is realized, for example, with “Simple Service Discovery Protocol” of UPnP (Universal Plug and Play) or other methods.

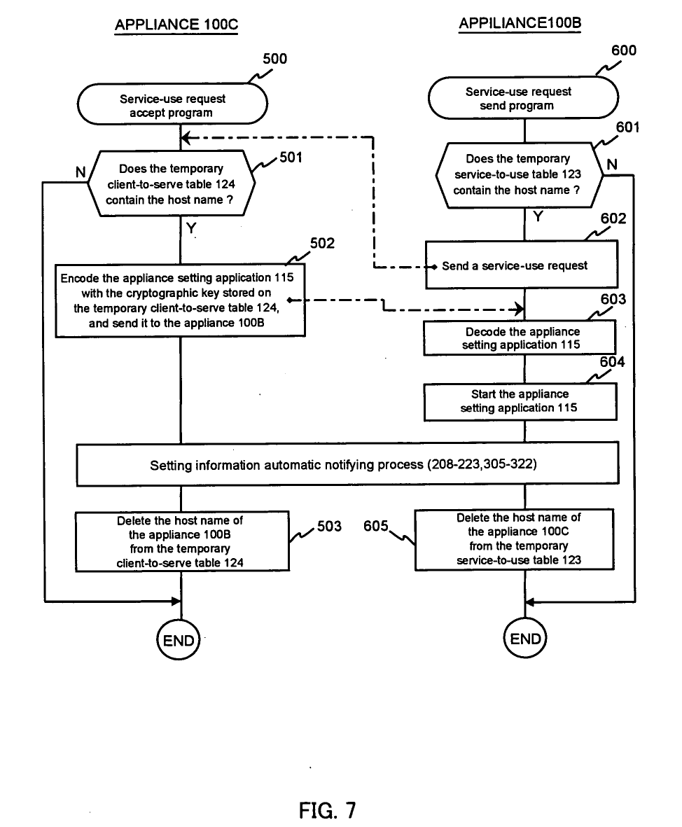

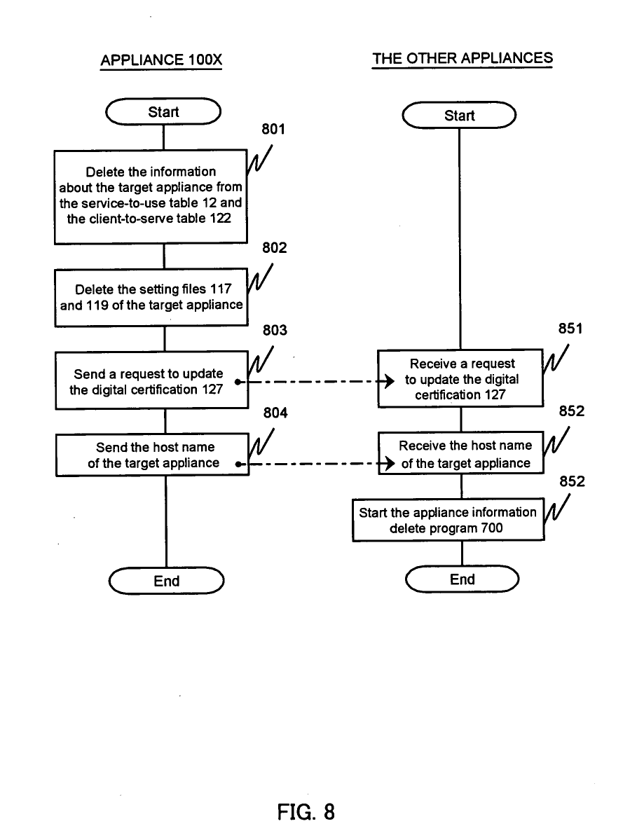

On detecting the service, the appliance 100B launches the service-use request send program 600. FIG. 7 is a flow chart showing a process executed after the appliance 100B detects the service of the appliance 100C.

In the first step, the appliance 100B determines whether or not its own temporary service-to-use table 123 contains the host name 126 of the appliance 100C which offers the detected service (601). In the second step, with determining that the information is contained (601: Y), the appliance 100B sends to the appliance 100C a service-use request encoded with the cryptographic key in the digital certification 127 stored on the temporary service-to-use table 123 (602). On receiving this request, the appliance 100C launches the service-use request accept program 500.

In the third step, the launched service-use request accept program 500 decodes the received service-use request with the cryptographic key in the corresponding digital certification 127 managed by the certification management application 114. Then, the appliance 100C determines whether or not its own temporary client-to-serve table 124 contains the decoded host name 126 of the appliance 100B (501).

In the fourth step, with determining that the information is contained (501: Y), the appliance 100C encodes the appliance setting application 115 with the cryptographic key in the digital certification 127 of the appliance 100B stored on the temporary client-to-serve table 123, and sends it to the appliance 100B (502).

In the fifth step, the appliance 100B decodes the received appliance setting application 115 with the cryptographic key in the digital certification 127 managed by the certification management application 114 (604), and launches the appliance setting application 115 (604).

In the sixth step, the appliances 100B and 100C take the same steps as 305 to 322 and 208 to 223 shown in FIGS. 3 to 6, to be able to use or offer the service. After these steps of configuring the required settings, the appliance 100C deletes the host names 126 of the appliance 100B from the temporary cline-to-serve table 124 (503), and the appliance 100B deletes the host name 126 of the appliance 100C from the temporary service-to-use table 123 (605).

In this way, in the appliance communication system 1 of the present embodiment, it is realized to configure the appliance setting information required for use of a service, just by connecting the data media 103 to the server appliance 100A, and then reconnecting the data media 103 to the client appliance 100B. In addition, it is also realized to automatically configure the appliance setting information required for the client appliance 100B to use a service of the third appliance joining the home network 50, or the appliance 100C. As a result, for example, assuming the appliance 100C provides a service of contents distribution, it becomes possible that the appliance 100B which is out of the house accesses the home network 50 through the Internet 102 and uses the contents distributed by the appliance 100C which is connected to the home network 50, without requiring for a user to manually configure the required appliance setting information.

Meanwhile, in the appliance communication system 1 described up until now, if the appliance 100C is not connected to the home network 50 when the setting information automatic notifying process is executed between the appliances 100A and 100B, it is possible that the appliance 100C does not register the information about the appliance 100B on its temporary client-to-serve table 124, because the appliance 100C does not have a chance to receive the host name 126 of the appliance 100B and the digital certification 127 of the appliance 100B. In this case, however, all it still takes is to carry out the setting information automatic notifying process between the appliances 100B and 100C, by connecting the data media 103 to the appliance When transferring or having lost an appliance 100, a user has to arrange that the appliance 100 can no longer use or offer a service in the home network 50. That is realized, for example, by first connecting the other appliance 100 which has any user interface (hereinafter referred to as appliance 100X) to the home network 50, and then providing the appliance 100X with the host name of the appliance 100 being deleted, and then launching the appliance information delete program 700 of the automatic information setting application 120 on the appliance 100X.

FIG. 8 is a flow chart showing a process executed by the appliance information delete program 700. In the first step, the appliance information delete program 700 launched on the appliance 100X deletes the information regarding to the appliance 100 being deleted, from its own service-to-use table 121 and client-to-serve table 122 (801). In the second step, the appliance information delete program 700 deletes the setting files 117 and 119 regarding to the appliance 100 being deleted (802). In the third step, the appliance information delete program 700 sends a request to update the digital certification 127, to each appliance 100 registered on the service-to-use table 121 and the client-to-serve table 122 (803 and 851). In the fourth step, the appliance information delete program 700 sends the host name 126 of the appliance 100 being deleted, to each appliance 100 registered on the service-to-use table 121 and the client-to-serve table 122 (804 and 852). On receiving this host name 126, each appliance 100 launches the appliance information delete program 700 of its own automatic information setting application 120, and deletes the corresponding information on the appliance 100 being deleted (853).

With taking the above-mentioned steps, the deletion of the information regarding to the appliance 100 is completed so that this appliance is no longer allowed to use or provide a service in the home network 50. Therefore, it can be prevented that an unauthorized person or a person with a bad idea accesses the home network 50 to use any function in it with use of the appliance transferred or lost.

Having described the preferred embodiment of the present invention with reference to the accompanying drawings, our aim is to facilitate the understanding of the present invention, and it is to be understood that the invention is not limited to the embodiment and that various changes and modifications could be effected therein by one skilled in the art without departing from the spirit or scope of the invention as defined in the accompanying claims, and that the invention may include equivalents thereof.

What is claimed is:

1. A setting information notifying method which is used to notify appliance setting information, the information required for use of a service between a first appliance and a second appliance, in an appliance communication system including the first appliance which is used with being connected to a communication network and the second appliance which is used with being connected to the communication network, the setting information notifying method, comprising the steps of:
the first appliance storing
a program which is used in notifying the said appliance setting information to the other appliance,
a first identifier assigned to the first appliance, and
a first cryptographic key of the first appliance, on a portable data media;
the second appliance starting the program stored on the data media, to obtain a first network address assigned to the first appliance based on the first identifier, and to establish a cryptographic communication path with the first appliance with use of the first cryptographic key stored on the data media;
the first appliance sending the appliance setting information to the second appliance, through the cryptographic communication path; and
the second appliance sending a second identifier assigned to the second appliance to the first appliance, through the cryptographic communication path.

2. A setting information notifying method according to claim 1, further comprising the step of:
the first appliance sending the first identifier to the second appliance, through the cryptographic communication path.

3. A setting information notifying method according to claim 1, further comprising steps of:
the first appliance managing an expiry date of the first cryptographic key;
the first appliance determining whether or not the expiry date of the first cryptographic key has expired when receiving from the second appliance a request to establish the cryptographic communication path; and
only if the expiry date of the first cryptographic key has not expired, then the first appliance sending the appliance setting information to the second appliance.

4. A setting information notifying method according to claim 1 or claim 2, further comprising the steps of:
the first appliance determining whether or not it stores a third cryptographic key, with regard to a third appliance which is used with being connected to the communication network; and
if the first appliance stores the third cryptographic key, then the first appliance sending to the second appliance the third cryptographic key and a third identifier assigned to the third appliance.

5. A setting information notifying method according to claim 4, further comprising the step of:
the first appliance encoding a second cryptographic key of the second appliance and the second identifier with use of the third cryptographic key, and sending them to the third appliance.

6. A setting information notifying method according to claim 4, further comprising the steps of:
the second appliance determining whether or not any service is offered by the third appliance in the communication network; and
if the second appliance detects a service which is offered by the third appliance in the communication network, then the second appliance receiving the appliance setting information from the third appliance, through the cryptographic communication with use of the third cryptographic key.

7. A first appliance, which is used with being connected to a communication network, and is included in an appliance communication system, in which a second appliance is also used with being connected to the communication network, and appliance setting information required for use of a service between the first appliance and the second appliance is notified, the said first appliance, comprising:
a software portion configured to store
a program which is used in notifying the said application setting information to the other appliance,
a first identifier assigned to the first appliance, and
a first cryptographic key of the first appliance, on a portable data media;
a software portion configured to establish a cryptographic communication path with the second appliance with use of the first cryptographic key; and
a software portion configured to send the appliance setting information to the second appliance through the cryptographic communication path.

8. A second appliance, which is used with being connected to a communication network, and is included in an appliance communication system, in which a first appliance is also used with being connected to the communication network, and appliance setting information required for use of a service between the first appliance and the second appliance is notified, the said second appliance, comprising:
a software portion configured to, from a data media which contains a program which is used in notifying the appliance setting information to the other appliance, a first identifier assigned to the first appliance, and a first cryptographic key of the first appliance, start the said program;
a software portion configured to obtain a first network address assigned to the first appliance based on the first identifier, and establish a cryptographic communication with the first appliance with use of the first cryptographic key stored on the data media; and
a software portion configured to send to the first appliance a second identifier assigned to the second appliance through the cryptographic communication.

9. A first appliance according to claim 7, further comprising:
a software portion configured to determine whether or not the first appliance contains a third cryptographic key, with regard to a third appliance which is used with being connected to the communication network; and
a software portion configured to send to the second appliance the third cryptographic key and a third identifier assigned to the third appliance, if the first appliance contains the third cryptographic key.

10. A first appliance according to claim 9, further comprising:
a software portion configured to encode a second cryptographic key of the second appliance and a second identifier assigned to the second appliance with use of the third cryptographic key, and send them to the third appliance.
